(19) United States
(12) Patent Application Publication
(10) Pub. No.: US 2018/0024736 A1
(43) Pub. Date: Jan. 25, 2018

(54) ELECTRONIC DEVICE AND TOUCH PANEL

(71) Applicant: ASUSTeK COMPUTER INC., TAIPEI (TW)

(72) Inventors: Hung-Yi LIN, TAIPEI (TW); Chin-Wen LIN, TAIPEI (TW); Jung-Hsing WANG, TAIPEI (TW)

(21) Appl. No.: 15/643,491

(22) Filed: Jul. 7, 2017

Related U.S. Application Data
(60) Provisional application No. 62/365,497, filed on Jul. 22, 2016.

(30) Foreign Application Priority Data
May 26, 2017 (TW) 106117725

(51) Int. Cl. G06F 3/0488; F21V 8/00; G06F 3/0484

(52) U.S. Cl. CPC G06F 3/04886; G06F 3/04847; G02B 6/0011; G06F 3/04883

(57) ABSTRACT

An electronic device is provided. The electronic device comprises a touch panel and a controller. The touch panel includes a touch layer, a sensing layer, and a light emitting layer. The touch layer includes a dielectric surface. The sensing layer is configured below the touch layer and configured to sense a touch operation on the dielectric surface to generate a touch signal. The light emitting layer includes a plurality of light emitting units. The light emitting layer is configured below the touch layer. The controller is electrically connected to the touch panel and configured to generate a control signal to turn on or off the light emitting units to generate at least a virtual key. A touch panel is also provided.

### CROSS-REFERENCE TO RELATED APPLICATION

This application claims the priority benefit of U.S. provisional application Ser. No. 62/365,497, filed on Jul. 22, 2016 and TW application serial No. 106117725, filed on May 26, 2017. The entirety of the above-mentioned patent applications are hereby incorporated by references herein and made a part of specification.

### BACKGROUND OF THE INVENTION

### Field of the Invention

The disclosure relates to an electronic device and a touch panel and, more specially, to an electronic device and a touch panel in which a virtual key is adjustable according to a touch gesture.

### Description of the Related Art

Generally, a mouse cursor is controlled by a user via a touch panel to operate a notebook computer. However, the position and the size of the touch panel of the notebook computer are usually fixed. The right and left entity keys are also configured at fixed positions of the touch panel. As a result, it is not applicable for more applications of different users.

### BRIEF SUMMARY OF THE INVENTION

According to an aspect of the disclosure, an electronic device is provided. The electronic device comprises a touch panel and a controller. The touch panel includes a touch layer including a dielectric surface; a sensing layer configured below the touch layer and configured to sense a touch operation on the dielectric surface to generate a touch signal; and a light emitting layer including a plurality of light emitting units. The light emitting layer is disposed below the touch layer. The controller is electrically connected to the touch panel and is configured to generate a control signal to turn on or turn off the light emitting units, to generate at least a virtual key.

According to another aspect of the disclosure, a touch panel adapted to an electronic device is provided. The touch panel comprises: a touch layer, a sensing layer, and a light emitting layer. The touch layer includes a dielectric surface. The sensing layer is disposed below the touch layer and configured to sense a touch operation on the dielectric surface to generate a touch signal. The light emitting layer includes a plurality of light emitting units. The light emitting layer is disposed below the touch layer. The light emitting units are turned on or turned off according to a control signal of the electronic device to generate at least a virtual key.

### BRIEF DESCRIPTION OF THE DRAWINGS

These and other features, aspects and advantages of the disclosure will become better understood with regard to the following embodiments and accompanying drawings.

FIG. 1A is a schematic diagram showing an electronic device in an embodiment;

FIG. 1B is a schematic diagram showing a touch panel in an embodiment;

FIGS. 2A˜2C are schematic diagrams showing a touch panel in an embodiment;

FIG. 3 is a schematic diagram showing a light emitting layer in an embodiment;

FIGS. 4A˜4B are schematic diagrams showing a touch panel in an embodiment;

FIGS. 5A˜5B are block diagrams showing a touch panel in an embodiment;

FIGS. 6A˜6C are schematic diagrams showing a method for dynamically adjusting a virtual key in an embodiment;

FIGS. 7A˜7B are schematic diagrams showing a virtual key in an embodiment.

### DETAILED DESCRIPTION OF THE EMBODIMENTS

These and other features, aspects, and advantages of the disclosure will become better understood with regard to the following description, appended claims, and accompanying drawings. However, the embodiments are not limited herein. The description of the operation of components is not used for limiting the execution sequence. Any equivalent device with the combination according to the disclosure is in the scope of the disclosure. The components shown in figures are not used for limit the size or the proportion.

The phase “electrically connected” refers to two or more components are connected physically or electrically with each other, directly or indirectly. The phase “electrically connected” further refers to two or more components are inter-operated or interacted with each other.

The terms, such as “comprise”, “include”, “contain” and “have/has”, are open-ended terms, which means “include but not limited to”.

The word “and/or” includes any one of one or more listed item(s) and all combinations thereof.

Unless mentioned otherwise, the terms used throughout the specification and the claims usually refer to their general meanings in the art, in the disclosure. Some terms used for describing the disclosure are discussed hereinafter or elsewhere in the specification to provide other understanding of the disclosure for the person having ordinary skills in the art.

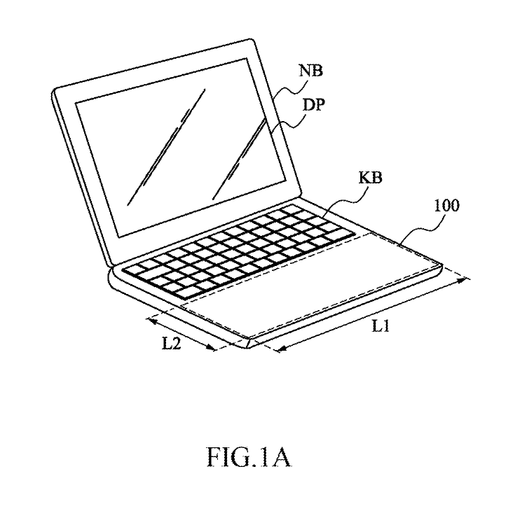

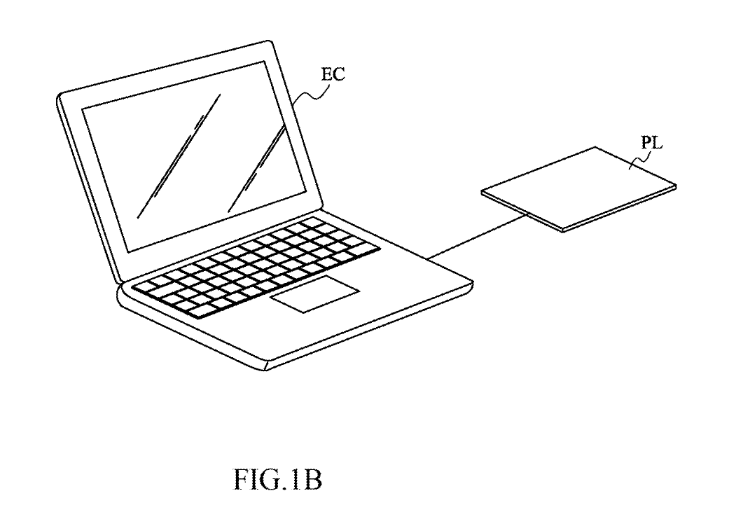

Please refer to FIGS. 1A˜1B. FIG. 1A is a schematic diagram showing an electronic device NB in an embodiment. FIG. 1B is a schematic diagram showing a touch panel PL in an embodiment.

As shown in FIG. 1A, in an embodiment, an electronic device NB includes a display DP, a keyboard KB and a touch panel 100. Features of the touch panel 100 are described in detail hereinafter. In an embodiment, the electronic device NB is a notebook computer, a hand-drawn device or other devices with a touch panel, which is not limited herein.

As shown in FIG. 1B, in an embodiment, an external touch panel PL is wiredly or wirelessly connected to the electronic device EC. The electronic device EC is a notebook computer, a smart phone, a tablet computer or any device is adapted to use the external touch panel PL.

In embodiments, the touch panel 100 built in the electronic device NB as shown in FIG. 1A and the external touch panel PL as shown in FIG. 1B have similar features, and they are applicable to the electronic device. In an embodiment, the touch panel 100 of the electronic device is exemplified for description and details of the touch panel 100 are described hereinafter. For better understanding, the electronic device NB is a notebook computer in the following embodiment.

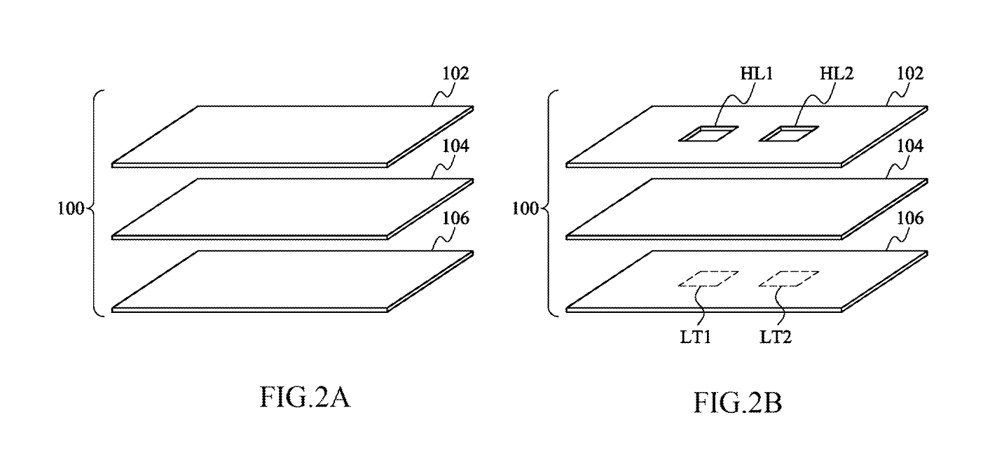

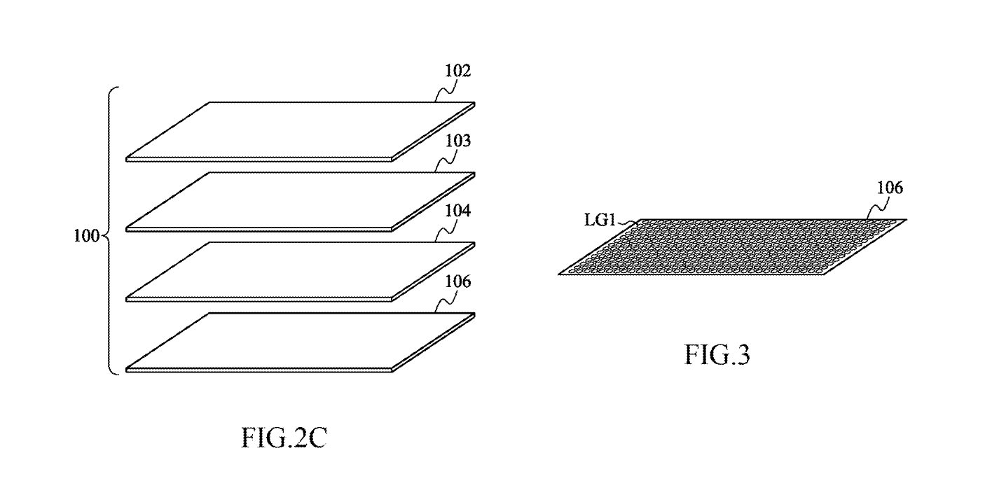

Please refer to FIGS. 2A˜2C. FIGS. 2A˜2C are schematic diagrams showing a touch panel 100 in an embodiment. In an embodiment, the touch panel 100 includes a touch layer 102, a sensing layer 104 and a light emitting layer 106. The light emitting layer 106 and the sensing layer 104 are disposed below the touch layer 102. In an embodiment, the light emitting layer 106 is disposed below the sensing layer 104. The sensing layer 104 is disposed below the touch layer 102. In the embodiment, the sensing layer 104 is a metal mesh. The metal mesh is transparent and stacked with the touch layer and the light emitting layer in such a way.

In an embodiment, the touch layer 102, the light emitting layer 106 and the sensing layer 104 are stacked from top to bottom to form the touch panel 100. In the embodiment, the sensing layer 104 is not transparent.

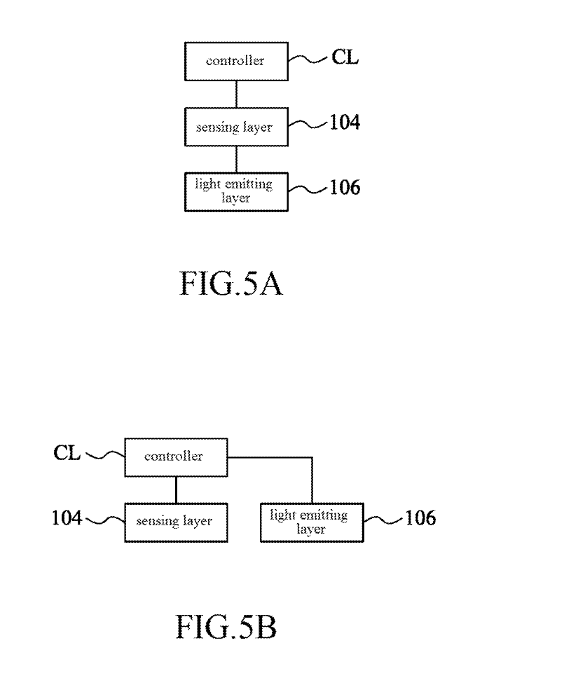

In an embodiment, the touch panel 100 is electrically connected to a controller. Details for the controller are described in following paragraphs regarding to FIGS. 5A˜5B.

In an embodiment, the touch layer 102 is configured to provide a dielectric surface for touches. In an embodiment, a finger slides on the touch layer 102 to control the mouse cursor. In an embodiment, the touch layer 102 includes mylar, glass, plastic or other dielectric materials. In an embodiment, the touch layer 102 includes transparent dielectric materials.

In an embodiment, the sensing layer 104 is used to detect a touch signal generated on the dielectric surface by a touch operation. In the embodiment, the sensing layer 104 includes capacitive materials, resistive materials, or other materials that are capable of detecting touch gestures.

In an embodiment, the light emitting layer 106 includes a plurality of light emitting units. At least one of the light emitting units is turned on to emit light. Details for the light emitting layer 106 are described hereinafter.

Please refer to FIG. 3. FIG. 3 is a schematic diagram showing a light emitting layer 106 in an embodiment. In the embodiment, the light emitting layer 106 includes a plurality of light emitting units (such as, a plurality of light emitting diodes). The light emitting layer 106 is a direct-type light-emitting diode (LED) array. In FIG. 3, multiple dots represent the LEDs LG1. LEDs have similar structures. In the embodiment, both the touch layer 102 and the sensing layer 104 are transparent. When at least part of the LED array of the light emitting layer 106 emits light towards the sensing layer 104, at least a part of the touch panel 100 is luminous. The luminous part of the touch panel 100 is considered as a virtual key.

In an embodiment that the direct-type LED array in FIG. 3 is applied as the light emitting layer, any part of the direct-type LED array can be driven to emit the light to present the virtual key. Thus, the virtual key is presented flexibly. In an embodiment, the light from the LEDs of the light emitting layer 106 pass through the touch layer 102 and sensing layer 104 which are transparent.

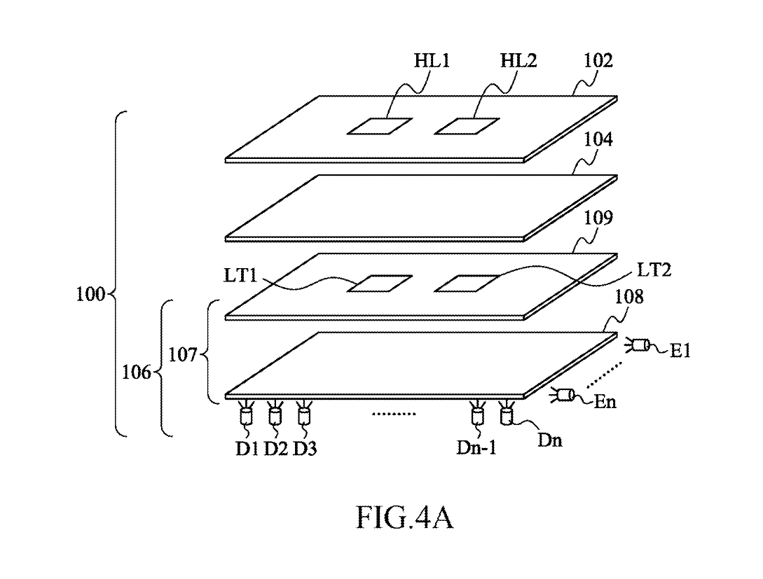

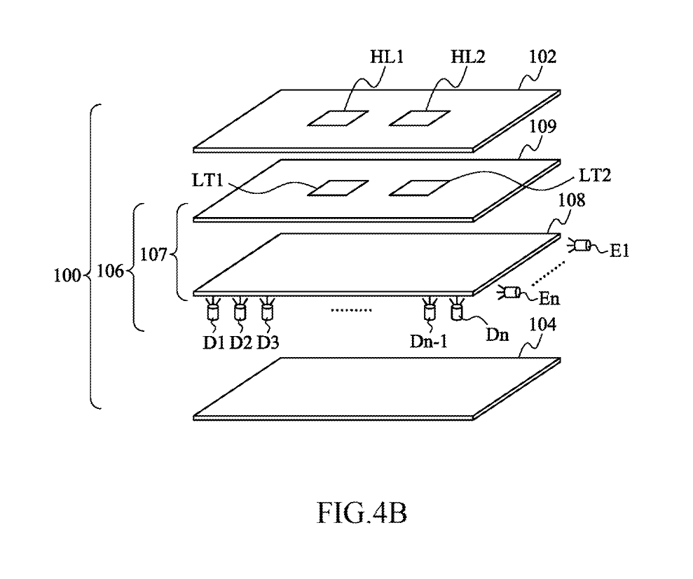

Please refer to FIGS. 4A˜4B. FIGS. 4A˜4B are schematic diagrams showing a touch panel 100 in an embodiment. In FIG. 4A, the light emitting layer 106 includes a light guiding layer 107 and the light emitting units E1˜En and D1˜Dn. The light guiding layer 107 includes a light guide plate 108 and a pattern layer 109. The pattern layer 109 is disposed on the light guide plate 108. The pattern layer 109 includes a plurality of transparent areas LT1 and LT2. The light emitting units (such as the light emitting diodes) E1˜En and D1˜Dn are disposed along at least two adjacent side edges of the light guide plate 108.

In an embodiment, when the controller receives a control command via a user interface (for example, a user interface of an application program is displayed on the display DP, a virtual key displayed on the touch panel 100 is enabled by a control command input from a mouse or other input devices). The controller sends a control signal to the touch panel 100 according to the control command to turn on the light emitting unit(s). Then, the virtual key is generated. As shown in FIG. 4A, the light guiding layer 107 is rectangle. The light emitting units E1˜En are disposed at a short side edge of the light guide plate 108. The light emitting units D1˜Dn are disposed at a long side edge of the light guide plate 108. The light emitted by the light emitting units E1˜En and D1˜Dn are guided to the whole light guide plate 108 via the light guide plate 108. In such a way, the number of the light emitting units is reduced to save the cost. In the embodiment, except the transparent areas LT1 and LT2, other areas of the pattern layer 109 are not transparent. In an embodiment, except the transparent areas LT1 and LT2, the light transmittance of other areas of the pattern layer 109 is much smaller than that of the transparent areas LT1, LT2. Therefore, a visual pattern is formed via some transparent areas of the pattern layer 109. In the embodiment, the touch layer 102 is made of transparent materials. Thus, the light that output from the transparent areas LT1, LT2 of the pattern layer 109 passes through the touch layer 102 to present the virtual keys HL1 and HL2.

In an embodiment, as shown in FIG. 4B, the touch layer 102, the light emitting layer 106, and the sensing layer 104 are stacked from top to bottom to form the touch panel 100. The difference between the embodiments in FIG. 4A and FIG. 4B is that the sensing layer 104 is disposed below the light emitting layer 106 in FIG. 4B. In an embodiment, the sensing layer 104 in FIG. 4B is not transparent. Other aspects of the embodiment in FIG. 4B are similar to the embodiment in FIG. 4A, which is not described hereinafter.

It can be seen that the light emitting layer 106 is implemented in the embodiments of FIG. 3 or FIGS. 4A˜4B and the related paragraphs.

Please refer to FIG. 2C. In an embodiment, the touch panel 100 further includes a light filtering layer 103. The light filtering layer 103 is disposed between the touch layer 102 and the sensing layer 104. In an embodiment, the light filtering layer 103 is disposed between the sensing layer 104 and the light emitting layer 106. In an embodiment, the light filtering layer 103 is disposed above the touch layer 102. In an embodiment, the light filtering layer 103 is formed below the touch layer 102 by laser carving after ink printing to have different transparences.

The light filtering layer 103 is used to filter the light emitted by the light emitting units. The light after filtered by the light filtering layer is uniform and homogeneous. The light filtering layer 103 is configured to adjust the luminance of the light. That is, the luminance of the light is adjusted by adjusting the transmissivity of the light filtering layer 103. Thus, the light after passing through the light filtering layer would not be too dazzling. In an embodiment, the light filtering layer 103 is configured to only allow the light of a certain spectrum (color) to pass through via filtering other light.

Please refer to FIGS. 5A˜5B. FIGS. 5A˜5B are block diagrams of a touch panel 100 in an embodiment. In an embodiment, as shown in FIG. 5A the controller CL is coupled to the sensing layer 104. The touch layer 105 (not shown) is disposed above the sensing layer 104. The touch layer 105 is made of dielectric materials and configured as a touch control interface. In an embodiment, the touch layer 105 is a polyester film. The sensing layer 104 is coupled to the light emitting layer 106. The controller CL is configured to send a control signal or an adjustment control signal to the light emitting layer 106 via the sensing layer 104 to turn on/off the light emitting units. In an embodiment, as shown in FIG. 5B, the controller CL is coupled to the sensing layer 104 and the light emitting layer 106, respectively, to send the control signal or the adjustment control signal to the light emitting layer 106 to turn on/off the light emitting units.

In an embodiment, as shown in FIG. 5A, the touch layer 102, the light emitting layer 106, and the sensing layer 104 are stacked from top to bottom to form the touch panel 100. In FIG. 5A, the control and coupling connections therebetween (details for which is not described hereinafter) are the same as those in the above-mentioned embodiment, but the stacking of the layers of the touch panel 100 is different.

In the embodiment, the controller CL controls the On/Off of light emitting units of the light emitting layer 106. In an embodiment, the light emitting layer 106 is implemented by a direct-type LED array. In an embodiment, the light guide plate 108 is used in the light emitting layer 106 to guide the light.

In an embodiment, the length (such as, the length L1 as shown in FIG. 1) of the touch panel 100 is approximately equal to the length of the notebook computer NB. The width of the touch panel 100 (such as the length L2 as shown in FIG. 1) is equal to a distance from a bottom edge of the keyboard KB to a long side edge of the surface with the keyboard KB of the notebook computer NB. In an embodiment, the area of the touch panel 100 is not limited herein.

In a following embodiment, the direct-type LED array in FIG. 3 is used as the light emitting layer, and a method for dynamically adjusting a virtual key is described.

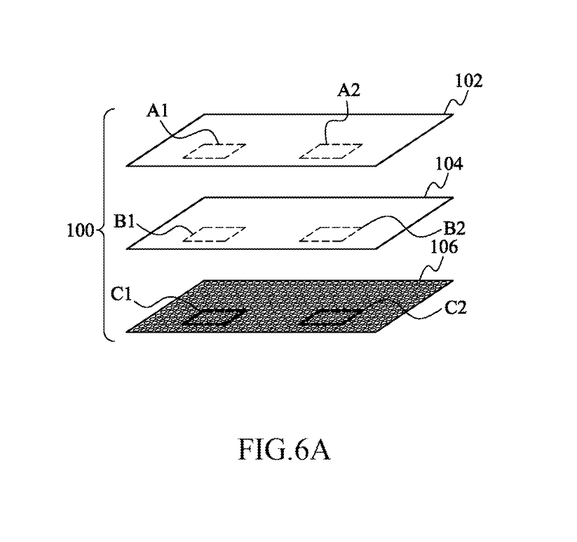

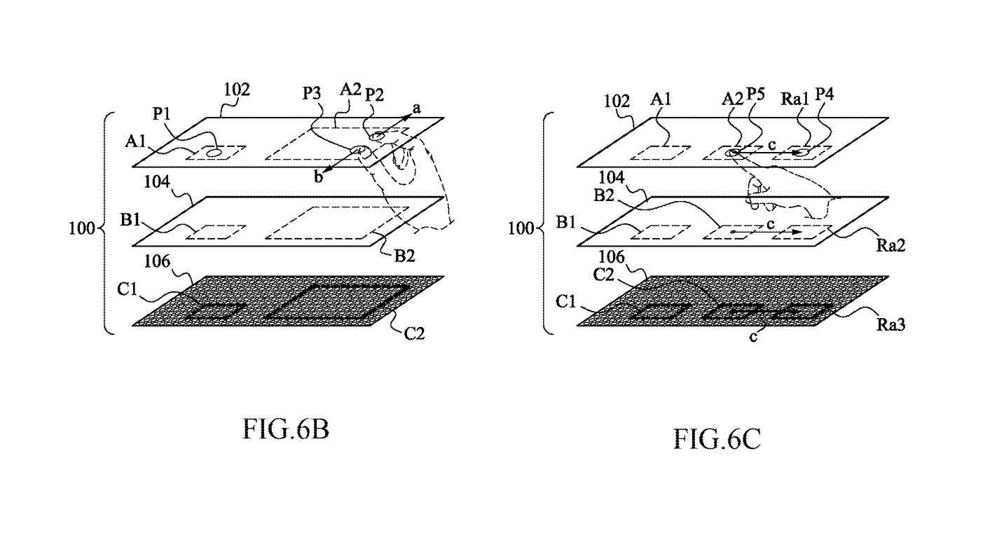

Please refer to FIGS. 6A˜6C. FIGS. 6A˜6C are schematic diagrams showing a method for dynamically adjusting a virtual key in an embodiment.

In an embodiment, the controller CL enters an adjustment mode when the controller CL receives an adjustment command The controller CL analyzes the touch signal received in the adjustment mode to determine a plurality of touch points on the touch layer that correspond to the touch control operation. The controller CL generates a corresponding adjustment control signal according to the positions of the touch points and turns on'off the light emitting units E1˜En and D1˜Dn according to the adjustment control signal, to adjust the positions or the sizes of the virtual keys A1 and A2. In the embodiment, the adjustment command is generated according to a touch control gesture, a press onto a shortcut key or a user interface. In an embodiment, a finger, a stylus, or other devices touches the dielectric surface (i.e., the touch layer 102) to generate the touch signal. The sensing layer 104 sends the touch signal to the controller CL.

In an embodiment, a plurality of the virtual keys are preset on the touch panel 100. As shown in FIG. 6A, a plurality of the light emitting units in the light emitting areas C1 and C2 of the light emitting layer 106 are enabled to allow the light from the light emitting areas C1 and C2 to pass through sensing areas B1 and B2 of the sensing layer 104 and display areas A1 and A2 of the touch layer 102, respectively. The position of the light emitting area C1 corresponds to the position of the sensing area B1 of the sensing layer 104 and the position of the display area A1 of the touch layer 102. The position of the light emitting area C2 corresponds to the position of the sensing area B2 of the sensing layer 104 and the position of the display area. A2 of the touch layer 102. In such a way, the display areas A1 and A2 on the touch layer 102 are regarded as the virtual keys. Details that the areas A1 and A2 of the touch layer 102 are considered as the virtual keys are described hereinafter.

In an embodiment, when the controller CL determines that a touch period of the touch gesture is longer than a time threshold (such as 0.5 minutes), the controller CL determine it received the adjustment command The controller CL controls the virtual key (such as the virtual key A2) to enter an adjustment mode (for example, the controller CL controls the light emitting area C1 to flicker, or shock, to present a moving or flickering virtual key A2, which means the adjustment mode is entered). The controller CL analyzes the touch signal received in the adjustment mode to determine a plurality of the touch points on the touch layer 102 that correspond to a touch operation (such as a drag gesture). The controller CL generates a corresponding adjustment control signal according to the positions of the touch points to turn on/off the light emitting units E1˜En and D1˜Dn according to the adjustment control signal. Then, the virtual key A2 moves along with the drag gesture, or the virtual key A2 is zoomed in/out or rotates according to other gestures.

In an embodiment, the controller CL analyzes a coordinate position where the touch signal is triggered, to recognize the touch gesture corresponding to the touch signal. As shown in FIG. 6B, when the user touches the touch panel at a touch point P1, the controller CL receives a touch signal corresponding to the touch point P1 and analyzes the coordinate position where the touch signal is triggered, to recognize an operation (such as a finger movement) on the virtual key A1.

In an embodiment, the controller CL analyzes the number of the coordinate positions corresponding to the touch signal to recognize the touch gesture corresponding to the touch signal, to generate the corresponding adjustment control signal. As shown in FIG. 6B, when the index finger of the user touches at a touch point P2 and the thumb touches a touch point P3, the controller CL analyzes that the number of the coordinate positions corresponding to the touch signal is two (which means two touch points P2 and P3 are touched by the user) and the touch points P2 and P3 are within the area of the virtual key A2. The controller CL recognizes the user's operation (such as the operation of zooming in/out or rotation) to the virtual key A2. The controller CL then sends a corresponding adjustment control signal to the touch panel 100.

In an embodiment, as shown in FIG. 6B, the controller CL analyzes the coordinate positions corresponding to the touch signal of each time point. The controller CL analyzes the touch signal. In an embodiment, The controller CL determines that the touch points on the touch layer 102 that correspond to the touch operation includes: the touch points touched by the finger when the user's finger moves from the touch point P2 along a direction a, and the touch points touched by the finger when the user's finger moves from the touch point P3 along a direction b. The controller CL generates the corresponding adjustment control signal according to the touch points to turn on/off the light emitting units of the light emitting layer 106. Then, the effect that the area of the virtual key A2 is enlarged is presented.

In an embodiment, as shown in FIG. 6C, the controller CL analyzes the touch signal to determine that the touch operation is that the user's finger moves from the touch point P4 to the touch point P5 along a direction c. The controller CL generates the corresponding adjustment control signal according to the positions of the touch points to turn on/off the light emitting units of the light emitting layer 106 (for example, the light emitting unit corresponding to the position Ra3 is turned on). Then, a visual effect that the virtual key A2 moves to the position Ra1 along the direction c according to the touch operation (the light emitting unit corresponding to the position Ra3 is turned on) is presented.

In an embodiment, the virtual key (such as the virtual key A2) is zoomed out/in, moves, rotates or changes the shape according to the touch gesture, which is not limited herein.

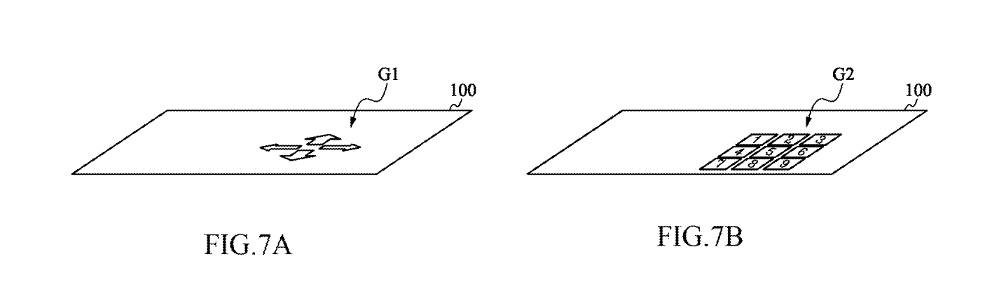

Please refer to FIGS. 7A˜7B. FIGS. 7A˜7B are schematic diagrams showing a virtual key in an embodiment.

In an embodiment, the controller CL obtains and recognizes information of a current application program. For example, in an embodiment, the controller CL obtains the information of the current application program from a processor (not shown) to know the current used application program (such as a browser, a multimedia player software and a computer software). Then, the controller CL generates a control signal according to the information of the current application program to turn on/off the light emitting units of the light emitting layer 106, to present a virtual key (such as the virtual key G1 shown in FIG. 7A) corresponding to the information of the current application program.

Please refer to FIG. 7A. In an embodiment, when the controller CL knows that the browser is currently used by the user according to the information of the current application program, the light emitting units of the light emitting layer 106 that correspond to the virtual key G1 are turned on by the controller CL while other light emitting units are turned off. Thus, the virtual key G1 is presented on the touch panel 100. The virtual key G1 includes up, down, left, right buttons for the user to move the whole website when the user browses the website.

Please refer to FIG. 7B. In an embodiment, when the controller CL knows that the multimedia player software is currently used by the user according to the information of the current application program, the controller CL turns on the light emitting units of the light emitting layer 106 that correspond to the virtual key G2 and turns off other light emitting units to present the virtual key G2 on the touch panel 100. The virtual key G2 includes a plurality of numeric key buttons for the user to quickly select audiovisual files corresponding to the number when the uses the multimedia player software. In an embodiment, when the controller CL knows that the computer software is currently used by the user from the information of the current application program, the controller CL controls the touch panel 100 to display the virtual key G2 to facilitate the data entry.

In an embodiment, when the controller CL receives an adjustment instruction from a user interface (such as a user interface of a touch panel control software) or an adjustment instruction of a shortcut signal (or a composite key signal) from a keyboard, the adjustment mode of the virtual key (such as the virtual key G1) is entered. The controller CL analyzes the received touch signal in the adjustment mode to generate the corresponding adjustment control signal. The controller CL adjusts a position, a size, a color, or a shape of the virtual key G1 according to the adjustment control signal.

In sum, in the embodiments of the electronic device and the method for dynamically adjusting the virtual key of the present disclosure, the size/position/shape of the virtual key can be dynamically adjusted, which facilitates the usage of the touch panel. The virtual key can be dynamically adjusted according to the different current application programs. Additionally, the virtual key can be defined according to the user' requirements.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. An electronic device comprising:
a touch panel including:
a touch layer including a dielectric surface; and
a sensing layer disposed below the touch layer and configured to sense a touch control operation on the dielectric surface to generate a touch signal;
a light emitting layer including a plurality of light emitting units and disposed below the touch layer; and
a controller electrically connected to the touch panel and configured to generate a control signal to turn on or off the light emitting units in order to generate at least a virtual key.

2. The electronic device according to claim 1, wherein the controller is configured to receive and analyze the touch signal to generate an adjustment control signal, and the controller is configured to turn the light emitting units on or off according to the adjustment control signal to adjust the virtual key.

3. The electronic device according to claim 1, wherein the light emitting units are light emitting diodes, and the light emitting layer is a direct-type LED array.

4. The electronic device according to claim 2, wherein the controller enters an adjustment mode according to an adjustment command, the controller analyzes the touch signal received in the adjustment mode to determine a plurality of touch points on the touch layer that correspond to the touch operation, the controller is configured to generate the adjustment control signal according to positions of the touch points, and the controller is further configured to turn the light emitting units on or off according to the adjustment control signal to adjust the position or the size of the virtual key.

5. The electronic device according to claim 1, wherein the light emitting layer further includes a light guiding layer with a light guide plate and a pattern layer, the pattern layer is configured above the light guide plate, and the light emitting units are configured on at least two adjacent side edges of the light guiding layer.

6. The electronic device according to claim 2, wherein the controller is coupled to the sensing layer, the sensing layer is coupled to the light emitting layer, the controller is configured to send the control signal or the adjustment control signal to the light emitting layer via the sensing layer to turn the light emitting units on or off.

7. The electronic device according to claim 2, wherein the controller is coupled to the sensing layer and the light emitting layer, respectively, and the controller is configured to send the control signal or the adjustment control signal to the light emitting layer to turn on or off the light emitting units.

8. The electronic device according to claim 1, wherein when the controller obtains information of a current application program, and the control signal is generated to turn on/off the light emitting units according to the information of the current application program, the virtual key corresponding to the information of the current application program is present.

9. The electronic device according to claim 1, wherein the touch panel further includes a light filtering layer, the light filtering layer is configured between the touch layer and the sensing layer, between the sensing layer and the light emitting layer, or above the touch layer.

10. The electronic device according to claim 1, wherein the sensing layer is configured above or below the light emitting layer.

11. A touch panel, adapted to an electronic device, the touch panel comprising:
a touch layer including a dielectric surface;
a sensing layer disposed below the touch layer and configured to sense a touch operation on the dielectric surface to generate a touch signal; and
a light emitting layer including a plurality of light emitting units and disposed below the touch layer, the light emitting units are turned on or turned off according to a control signal from the electronic device to generate at least a virtual key.

12. The touch panel according to claim 11, wherein the light emitting units are turned on or off according to an adjustment control signal from the electronic device that corresponds to the touch signal, to adjust the virtual key.

13. The touch panel according to claim 11, wherein the light emitting units are a plurality of light emitting diodes, and the light emitting layer is a direct-type LED array.

14. The touch panel according to claim 12, wherein the light emitting units are turned on or turned off individually according to the adjustment control signal that correspond to a plurality of touch points on the touch layer, to adjust the position or the size of the virtual key.

15. The touch panel according to claim 11, wherein the light emitting layer further includes a light guiding layer with a light guide plate and a pattern layer, the pattern layer is configured on the light guide plate, and the light emitting units are configured on at least two adjacent side edges of the light guiding layer.

16. The touch panel according to claim 12, wherein the sensing layer is coupled with the light emitting layer and a controller of the electronic device, the light emitting layer is configured to receive the control signal or the adjustment control signal from the controller via the sensing layer, to turn the light emitting units on or off.

17. The touch panel according to claim 12, wherein the light emitting layer is coupled to a controller of the electronic device and the sensing layer, respectively, the light emitting layer is configured to receive the control signal or the adjustment control signal from the controller.

18. The touch panel according to claim 11, wherein the control signal is corresponding to information of a current application program, and the light emitting units are turned on or turned off according to the control signal, to present the virtual key that is corresponding to the information of the current application program.

19. The touch panel according to claim 11, wherein the touch panel further includes a light filtering layer, the light filtering layer is disposed between the touch layer and the sensing layer, or between the sensing layer and the light emitting layer, or above the touch layer.

20. The touch panel according to claim 11, wherein the sensing layer is disposed above or below the light emitting layer.
